(19) United States
(12) Patent Application Publication
(10) Pub. No.: US 2010/0023356 A1
(43) Pub. Date: Jan. 28, 2010

(54) Method of Promoting Employee Wellness And Health Insurance Strategy For Same

(76) Inventor: Douglas J. Short, Fort Wayne, IN (US)

Correspondence Address: LIELL & MCNEIL ATTORNEYS, PC, P.O. BOX 2417, 511 S. MADISON ST., BLOOMINGTON, IN, 47402, US

(21) Appl. No.: 12/550,616

(22) Filed: Aug. 31, 2009

Related U.S. Application Data
(63) Continuation of application No. 10/652,849, filed on Aug. 29, 2003.
(60) Provisional application No. 60/486,846, filed on Jul. 11, 2003.
(60) Provisional application No. 60/493,758, filed on Aug. 8, 2003.

(51) Int. Cl. G06Q 40/00; G06Q 50/00

(52) U.S. Cl. 705/4

(57) ABSTRACT

In an effort to reduce employer health insurance related costs, a state-governed fully-insured health insurance policy is provided for a group of employees. At least one benefit under the health insurance policy is conditional on the employee voluntarily participating in a wellness program. The wellness program could include wellness categories such as a tobacco free category, normal blood pressure category, regular exercise category and even a non-overweight category. In addition, the wellness program could condition coverage, or subsidize deductibles for, certain illnesses on employee submission to screening tests on a prescribed basis for the identified illness, such as cancer screening for early detection of cancer. The voluntary wellness program can also include a variety of other aspects including wellness education, disease inoculation, and injury prevention. The invention provides an incentive for employees to make healthier lifestyle choices.

### RELATION TO OTHER PATENT APPLICATIONS

This application is a Continuation of U.S. patent application Ser. No. 10/652,849, filed Aug. 29, 2003, which claims the benefit of provisional patent application Ser. No. 60/486,846, filed Jul. 11, 2003, and provisional patent application Ser. No. 60/493,758, filed Aug. 8, 2003.

### TECHNICAL FIELD

The present invention relates generally to incentives to promote wellness in a group of employees, and more particularly to an insurance strategy that utilizes a state-governed fully-insured health insurance policy with benefits contingent upon an employee adopting aspects of a healthy lifestyle, such as refraining from tobacco usage.

### BACKGROUND

A variety of strategies have been tried by various employers over the past years in an effort to reduce healthcare associated costs for their employees. For instance, some employers have tried a cost shifting strategy by requiring employees to pay a portion of the premiums for their health insurance. In other cases, employees are given choices to tailor a health insurance product to suit their individual needs, such as a high deductible, whereas another employee can choose a different set of benefits at a different contributory cost. In other attempts to control costs, employers provide wellness programs to their employees in the hopes of reducing future healthcare costs. Unfortunately, in many instances the persons most in need of changing to a healthier lifestyle are the last ones to take advantage of employer provided wellness programs.

There are also tax consequences to consider. Under current law, an employer can financially reward employees that adopt a healthier lifestyle by maintaining a weight within certain healthy parameters, maintaining an acceptable blood pressure level, and not smoking, etc. However, these financial incentives would be considered as taxable compensation to the employee under the current tax code. In other words, the value of the financial incentive should appear on an employee's W-2 tax statement at the end of the year, with both the employee and employer paying taxes regarding that benefit. On the other hand, the tax code provides for health insurance benefits to be both tax deductible by the employer and non-taxed compensation to the employee. Thus, while financial rewards for adopting healthier lifestyles can potentially reduce healthcare costs in the long term, these gains can be offset by additional tax burdens for both employer and employee.

The present invention is directed to providing a financial incentive to adopt a healthier lifestyle for a group of employees without increasing a tax burden on either the employer or employees.

### SUMMARY

In one aspect, a method of reducing employer costs includes a step of providing a state-governed fully-insured health insurance policy for a group of employees as a non-taxed compensation to each employee, but as a tax deductible expense to the employer. At least one benefit under the policy is conditioned on the employee voluntarily participating in a wellness program.

In another aspect, an employer provided health insurance product includes a state-governed fully-insured health insurance policy for a group of employees that is a tax deductible expense to the employer while being non-taxed compensation to the employee. At least one benefit under the policy is conditioned on the employee's voluntary participation in at least a portion of a wellness program.

In another aspect, a method of administering an employee health plan includes a step of determining whether a conditional benefit under a state-governed fully-insured health insurance policy is available to an employee making a claim. This is done at least in part by determining whether the employee is a voluntary participant in a wellness program. The claim is processed with respect to the state-governed fully-insured health insurance policy if the conditional benefit is available to the employee.

### DETAILED DESCRIPTION

At the core of the present invention is a state-governed fully-insured health insurance policy that is provided by an employer to a group of employees. Under current tax laws, the health insurance coverage is treated as non-taxable compensation to the employee, but treated as a tax deductible expense for the employer. The term “state-governed” is intended to mean a health insurance product that is governed by one or more of the individual states of the United States, as opposed to an ERISA based health insurance policy that is governed under federal law. The term “fully-insured” is a term of art in the insurance industry meaning generally that in exchange for premium payments, which would be paid at least partially by the employer, coverage according to the insurance contract is provided for insured employees. A person can be fully insured and still have an obligation to make partial premium payments or co-payments for benefits and still have certain limitations on the scope of coverage, namely limitations on specific diseases or conditions for which coverage is afforded, and limitations on the treatment regimens authorized. While federal law prohibits ERISA based insurance policies from discriminating in virtually any way in coverage provided to employees, state-governed fully-insured health insurance policies have no such restriction. It is this aspect of state-governed health insurance policies that help enable the present invention. As a consequence, if the state-governed health insurance policy covers a group of employees in more than one state, at least the administrator of the policy would have to become licensed in each such state according to the laws and rules of that individual state in order to administer the state-governed health insurance product.

The present invention recognizes that healthier employees will reduce employer costs by statistically having less and smaller healthcare related claims. However, the present invention also recognizes that, in many or most instances, it is individual decisions and behavior that serve to improve one's health. The present invention seeks to provide an incentive for individuals to make healthier lifestyle choices. In a preferred version of the present invention, these incentives are financial. In this regard, the present invention recognizes that a dollar spent to create an incentive for a healthier lifestyle for an individual can reap many dollars in potential savings via a lesser number of, and likely a smaller value for, health insurance claims that the individual may make in the future. In addition, these gains can also be leveraged by the fact that, on average, healthier employees are more productive than less healthy employees. Under the present invention, the state-governed fully-insured health insurance policy that an employer provides for their employees includes at least one conditional benefit under the policy that is conditioned on the employee's voluntary participation in a wellness program. A wellness program includes, but is not limited to one or more of wellness categories, wellness education, disease inoculation, targeted illness screenings, and injury prevention. The wellness categories could include, but are not limited to a tobacco free category, a normal blood pressure category, a non-overweight category and a regular exercise category. Wellness education might include, but is not limited to, stress management education, relaxation techniques instruction, self-defense instruction and many others known in the art. A disease inoculation aspect of a wellness program could include an annual flu shot or some other inoculation known in the art. An injury prevention aspect of a wellness program could include features such as wearing seatbelts when a passenger in a motor vehicle, or having smoke detectors installed in one's home, and many other known steps that can decrease the likelihood of a future injury. A wellness program under the invention is voluntary, in that the employee is free to decide on participation or not. In other words, participation is in no way mandated by the employer.

In one example, an employer might currently offer an ERISA governed healthcare plan that provides for a $500.00 deductible. Those skilled in the art will appreciate that ERISA governed health insurance plans cannot, by law, discriminate against any employees for any reason. When the present invention is implemented, the employer raises the deductible to $2500.00 per person and allows for four advantage pools. Among these are 1) weight within a healthy range, 2) blood pressure within a healthy range, 3) non-tobacco usage, and 4) regular physical exercise. For each of these categories the employee would be granted a $500.00 advantage credit under a state-governed fully-insured companion health insurance policy to be applied against their deductible expense. For instance, if they are a non-smoker and they participate in regular exercise, they would qualify for $1,000.00 of advantage credits to be spent toward their $2,500.00 deductible. Should they not qualify for any of the advantage pools described, the employee will absorb a larger deductible.

Another aspect of a voluntary wellness program could potentially include illness screenings to detect certain identified targeted illnesses. This aspect of the invention recognizes that the magnitude of a healthcare claim necessary to make a person well can be greatly influenced by the stage of the identified illness when treatment begins. For instance, many cancers, such as breast cancer and colon cancer, can be effectively and successfully treated at a relatively low cost if the cancer is detected early. Thus, a state-governed fully-insured health insurance policy according to the present invention might condition coverage, or a portion thereof, for an identified illness on whether the claimant took advantage of an illness screening for that identified illness before or contemporaneously with detection of the identified illness. For instance, an employee who has regular screenings for breast cancer according to a schedule suggested by the American Cancer Society would receive full coverage for any breast cancer related claim that might occur. On the other hand, an employee who refrains from screening tests for breast cancer but later requires treatment for a relatively advanced case of breast cancer might have a higher deductible for a breast cancer related claim or might receive limited or no coverage for a breast cancer based claim. Those skilled in the art will appreciate that there are a wide variety of potential illnesses that can be screened against, and new screening tests for different illnesses are often being introduced. For example, illness screenings could include cancer screens, heart disease screens, abnormal vision screens, abnormal orality screens, mental illness screens and a wide variety of other screening tests known in the art. In a preferred version of the present invention, the health insurance policy would provide coverage to pay for the screening tests that are intended to detect certain identified illnesses early so that the same can be treated successfully and at a relatively lower cost.

Thus, a voluntary wellness program according to the present invention can, and likely would, come in a wide variety of forms suited to a particular employee population. On one hand, an employee that chooses to remain tobacco free, has a normal blood pressure, is not overweight, regularly exercises, is screened for certain identified illnesses on a prescribed frequency, and engages in a variety of other healthy lifestyle choices would receive the maximum benefits available under the employer provided state-governed fully-insured health insurance policy. On the other hand, an overweight employee who does not exercise, has high blood pressure and smokes, avoids any illness screenings and engages in a variety of other unhealthy lifestyle choices would receive minimal coverage under the employer provided health insurance policy. Thus, the present invention seeks to shift the costs of healthcare to those persons whose individual decisions produce the risk of healthcare claims, but in no way mandates participation in any wellness program.

While employers may opt to provide only a state-governed fully-insured health insurance policy for their employees, many current employers provide health insurance coverage under an ERISA governed health insurance policy that prohibits any activity regarded as discriminatory against one or more of the employees relative to others. Those employers might opt to incorporate the present invention by increasing a deductible on their current ERISA governed health insurance plan, and purchase a new state-governed fully-insured health insurance policy to conditionally cover the deductible increase. In other words, an employee who fully qualifies at the initiation of the new health insurance plan to participate in all of the defined wellness program will see no difference in their health insurance coverage. On the other hand, employees who do not participate in the new wellness program will obtain no benefits under the state-governed health insurance policy and thus will continue coverage only under the ERISA governed plan, but they will experience a higher deductible.

Clearly there would need to be criteria to each of these advantage pools. For instance, it might be desirable to provide verifiable standards, or it may operate on an honor system, or a combination of both. For instance, weight might be verified on a periodic basis by merely stepping on the scales and comparing the employees weight to what their weight should be under certain height and weight guidelines. On the other hand, whether the employee engages in regular exercise could be merely on an honor system without any substantial verification.

If we utilize this program in an example, the carrier will reduce your aggregates, giving a one to one savings against all claims spent between the $500.00-$2500.00 example yielding a net savings to the plan. One would anticipate about 40% of the people qualifying for all four wellness categories. The remaining employees might qualify for some variation of the four and therefore save the corporation the difference. The incentives provided under this strategy could progress to incentives for dependents as well, but employees would be a good starting point.

If a person is maintaining a healthy lifestyle, this will have a beneficial affect on the health insurance plan losses, and will likely hasten an employee's recovery time after illness or surgery. If the employee does not participate, they would qualify for a higher deductible.

One should also keep in mind that every dollar currently spent on healthcare, between a current employee's deductible and the carrier's specific threshold deductible is all employer money. The incentive provided by the present invention would help to control the expense of that fund. Further, if employees do not participate in the wellness incentives, their deductible or out-of-pocket healthcare expenses will be commensurate with their lifestyle choices.

The unique opportunity to categorize participants is found only by a new relationship. Presently, it is generally not possible to categorize employees under any other system and maintain the tax advantages, and there are also very few insurance administration companies that are licensed to administer both an ERISA based health plan and a state-governed medical reimbursement plan seamlessly. An employee would likely never see the separation of the two structures. However, all claims would be handled as a single claim submission, as it is currently done.

In order to potentially be an administrator of such a health insurance strategy, an administrator would likely need to become licensed to administer both self funded and fully-insured plans in almost every State in the country. Furthermore, that administrator would likely need to secure contracts with fully-insured carriers around the country that would compliment their existing clients. Thus, the present invention can marry a discriminatory State licensed fully-insured incentive program to an existing Federally license, non-discriminatory health plan to create unique savings for both employer and employees.

In another aspect of the invention, an employer provides only a single fully-insured healthcare policy for covering their group of employees. Certain benefits under that policy would be contingent upon an employee participating in a wellness program that might include certain wellness categories, such as those described above. For instance, an employee who participated in regular exercise, refrained from smoking, maintained a healthy body mass index and maintained a normal blood pressure, would receive the maximum amount of benefits available under the policy. Another employee who participated in none of the wellness categories might receive some healthcare benefits or might have to pay a much higher deductible under the policy due to their lifestyle choices. In other words, under the present invention, those who take steps to maintain wellness through a healthier lifestyle will be rewarded with the maximum coverage under a healthcare policy. Whereas, those who choose riskier behaviors, such as smoking, will have to pay a proportionally higher portion of their healthcare costs due to the decreased amount of benefits afforded to them under the employer's policy. Thus, in this alternative, no dual insurance health plan is required. Instead, the employer simply provides one state-governed fully-insured plan that includes a variety of benefits that are contingent upon the employee engaging in certain healthy lifestyle choices.

In another aspect of the invention, identifiable populations in an employee work force can be targeted to potentially reduced long term healthcare costs. For instance, certain benefits under the health plan could be contingent upon women employees over a certain age having regular mammogram screenings. In another example, the population of men over age forty (40) could be targeted by conditioning certain benefits under their healthcare policy upon them taking regular prostate screenings to detect prostate cancer. In both of these instances, the employee would be rewarded for making healthy lifestyle choices that include screening for certain illnesses and diseases when they can be detected and treated relatively inexpensively and effectively. For instance, in the case of prostate cancer, the health insurance policy might specifically exclude or severely limit coverage for prostate cancer if the employee fails to obtain prostate screening tests on the schedule prescribed by the policy, which could incorporate recommendations by the American Cancer Society.

Another employer may choose a wellness program that includes targeted illness screenings. This aspect of the invention recognizes that the costs associated with screenings for certain illnesses can substantially reduce potential claims for those illnesses in the future. In other words, many illnesses can be treated successfully and at a relatively low cost if caught early. Thus, the state-governed fully-insured health insurance policy might include coverage for preventative healthcare such as certain targeted illness screenings, but severely limit or exclude coverage for those illnesses if the employee fails to take advantage of an illness screening according to a prescribed schedule that may be included in the policy. The prescribed schedule would likely be different for different illnesses and may be based on established norms, such as various screening procedures and frequencies suggested by the American Cancer Society. Those skilled in the art will recognize that many illnesses can be screened for, and these screening tests are often relatively inexpensive with new procedures being introduced every year. If this aspect of the present invention were incorporated into an employer's wellness program, the state-governed fully-insured health insurance policy could, and likely would need to be, updated on a yearly basis to reflect advances in illness screening technology and techniques. An employer might improve this aspect of the invention by taking steps to make screening test opportunities more available to employees through a variety of techniques known in the art.

In another aspect of the present invention, an employer might include wellness education participation and possibly even voluntary public service as conditions for certain benefits under a state-governed fully-insured health insurance policy. For instance, the employee might receive a financial credit to be applied against any healthcare claims for each wellness education course that employee attends. These wellness education courses could include everything from self-defense instruction to nutrition instruction. This aspect of the invention recognizes that providing individuals with the knowledge of how to make healthier lifestyle choices will increase the likelihood that the employee will actually make those healthier lifestyle choices. Again, healthier lifestyle choices will, on average, result in a lesser number of, and smaller dollar amount value for, healthcare related claims. An employer can further leverage this aspect of the invention by, for instance, offering wellness education programs on company property during convenient times, such as during lunch hours or immediately following the end of a shift, or at any other time and place that is convenient to employees.

An employer might also choose a wellness program that includes disease inoculation and/or injury prevention aspects according to the present invention. For instance, a disease inoculation aspect of the present invention might allow for the state-governed fully-insured health insurance policy to pay for flu shots, or the employer might provide flu shots outside of the policy at a convenient time and place for employees. However, doctor visits in the same year that are due to flu would be excluded from coverage if that employee refused a flu shot earlier in the year. An injury prevention aspect of the present invention might limit medical payments for injuries received in a motor vehicle accident if the employee was without a seat belt at the time of the injury. In another application, the state-governed fully-insured health insurance policy may decrease a net deductible for a claim resulting from fire injuries in an employee home having smoke alarms. Those skilled in the art will appreciate that, depending upon the type of condition applied, that a wide variety of administrative techniques and verifications could be utilized to process claims that may be subject to a conditional benefit.

In still another aspect of the invention, the cost savings afforded by the basic invention can be leveraged by an employer taking other actions. For instance, while the present invention provides an incentive to maintain wellness, an employer can also provide opportunities to improve wellness. For instance, an employer might consider providing an exercise area and/or equipment on company property for employee use. In another example, an employer might have blood pressure testing equipment and/or weight scales distributed throughout the corporate property to afford employees the opportunity to monitor their wellness in regard to weight and blood pressure. One could expect that by providing opportunities for healthy lifestyle choices and providing an incentive to adopt healthier lifestyle choices, an employer could expect a symbiotic relationship between these two strategies for reducing healthcare costs.

In one aspect, an employer would provide employees with health insurance coverage under two separate health insurance policies. The first policy would look much like the health insurance policies currently provided by most employers in that it would be a group insurance policy governed federally under ERISA. This first policy might have a relatively high deductible. The second health insurance policy would be a fully-insured policy governed by each of the individual States, and would have discriminatory features not permitted by ERISA governed plans. For instance, the second policy could provide coverage for a substantial portion, if not all, of the gap created by the deductible for the ERISA governed health policy. However, benefits under the second policy would be conditional on an employee satisfying certain wellness conditions through participation in a wellness program. For instance, a fraction of the deductible for the first policy could be covered under the second policy if the employee were to maintain a certain height and weight ratio or body mass index. Another fraction would be conditioned upon the employee refraining from tobacco usage. A third fraction might be conditional upon an employee maintaining a certain blood pressure level. Still another fraction could be conditional upon the employee engaging in regular exercise. Such a strategy would provide an expanded range of healthcare coverage for employees who engage in a healthy lifestyle, whereas employees who do not engage in a healthier lifestyle are still insured under the ERISA governed health insurance policy, but must absorb the costs themselves for the higher deductible. Because both the conditional and non-discriminatory aspects of the health insurance strategy are provided via health insurance products, the benefits are neither taxable to the employees nor the employer, and the employer may take a tax deduction for all the premium costs associated with both health insurance products.

Those skilled in the art will appreciate that the above description is intended for illustrative purposes only, and is not intended to limit the scope of the present invention in any way. For instance, those skilled in the art will no doubt identify other ways in which individual choices and behavior can be assessed for the risk of a possible future health care claim, and a conditional benefit can be crafted to give an incentive to the employee to make healthier choices or engage in healthier behavior, or otherwise risk shouldering the financial burden for their unhealthy choices. In other words, the present invention seeks to better allocate the risk of, and magnitude of, healthcare claims to the choices and behavior that statistically tend to give rise to particular health related insurance claims. While some of the discussion above refers to across the board deductible changes, the invention also contemplates disease specific deductible changes linked to a specific aspect of a wellness program, or a combination of both. In addition, the invention also contemplates adjusting a time cap for benefits under a health insurance policy based on participation, or lack thereof, in a wellness program. Thus, those skilled in the art will recognize many different ways in which a wellness program can be constructed according to the present invention beyond the illustrated examples discussed above, without departing from the scope of the invention as defined by the claims set forth below.

What is claimed is:

1. An improved method of allocating employer costs for employee health benefits, comprising the steps of:
providing a state-governed fully-insured health insurance policy to a group of employees as a non-taxed compensation to an employee, but as a tax deductible expense to the employer;
conditioning a benefit under the state-governed fully-insured health insurance policy for the employee to participation in a voluntary wellness program;
wherein the state-governed fully-insured health insurance policy is a portion of an insurance contract that provides coverage to the employees in exchange for premium payments paid at least partially by the employer to an insurance provider; and
wherein said wellness program includes a wellness category that includes at least one of a tobacco free category, a normal blood pressure category, a non-overweight category and a regular exercise category.

2. The method of claim 1 including the steps of:
providing an ERISA governed health insurance policy to employees as a non-taxed benefit to an employee, but as a tax deductible expense to the employer;
structuring the state-governed fully-insured health insurance policy to cover a healthcare expense not covered by the ERISA governed health insurance policy.

3. The method of claim 2 wherein a conditional benefit under the state-governed fully-insured health insurance policy includes coverage for at least a portion of a claim falling within a deductible for the ERISA governed health insurance policy.

4. The method of claim 2 includes the steps of:
increasing a deductible on the ERISA governed health insurance policy relative to a previously provided ERISA governed health insurance policy; and
making a conditional benefit under the state-governed fully-insured health insurance policy cover at least a portion of the deductible increase.

5. The method of claim 1 wherein said wellness program includes at least one illness screening; and
said step of conditioning a benefit includes a step of conditioning coverage for at least a portion of an identified illness to employee participation in an illness screening for the identified illness.

6. The method of claim 5 wherein an identified illness includes at least one of cancer, heart disease, abnormal vision, abnormal orality, and mental illness; and
said at least one illness screening includes a cancer screen, a heart disease screen, an abnormal vision screen, an abnormal orality screen and a mental illness screen.

7. The method of claim 1 wherein said wellness program includes at least one of wellness education, disease inoculation, injury prevention and voluntary public service.

8. The method of claim 1 including a step of providing employees with opportunities to at least one of improve and monitor their wellness condition.

9. A method of administering a health plan for a group of employees, comprising the steps of:
determining whether a conditional benefit under a state-governed fully-insured health insurance policy is available to an employee making a claim at least in part by determining whether the employee is a participant in a voluntary wellness program; and
processing the claim with respect to the state-governed fully-insured health insurance policy if the conditional benefit is available to the employee;
wherein the state-governed fully-insured health insurance policy is a portion of an insurance contract that provides coverage to the employees in exchange for premium payments paid at least partially by the employer to an insurance provider; and
processing the claim with respect to an ERISA governed health insurance policy that is a companion to the state-governed fully-insured health insurance policy.

10. The method claim 9 wherein the processing steps include the steps of:
applying the claim to a deductible under the ERISA governed health insurance policy; and
paying at least a portion of the claim under state-governed fully-insured health insurance policy.

11. The method of claim 9 wherein said wellness program includes at least one wellness category that includes at least one of a tobacco free category, a normal blood pressure category, a non-overweight category and a regular exercise category; and
said processing step includes a step of paying at least a portion of the claim if the employee was a member of at least one of said wellness categories before incurring the claim.

12. The method of claim 9 wherein said wellness program includes an illness screening for at least one identified illness; and
said determining step includes a step of determining if the claim is based at least in part on said identified illness and whether the employee participated in an illness screening for said identified illness before incurring the claim.

13. The method of claim 9 wherein said wellness program includes at least one of wellness education, disease inoculation, injury prevention and voluntary public service; and
said determining step includes a step of determining whether the employee participated in at least one of wellness education, disease inoculation, injury prevention and voluntary public service before incurring the claim.
